(19) United States
(12) Patent Application Publication
(10) Pub. No.: US 2006/0162447 A1
(43) Pub. Date: Jul. 27, 2006

(54) Piezoelectric vibration gyro element, structure for supporting the piezoelectric vibration gyro element and gyro sensor

(76) Inventor: Seiichiro Ogura, Nagano-ken (JP)

Correspondence Address: ANDERSON KILL & OLICK P.C., 1251 Avenue of the Americas, New York, NY, 10020, US

(21) Appl. No.: 11/331,417

(22) Filed: Jan. 11, 2006

(30) Foreign Application Priority Data
Jan. 21, 2005 (JP) 2005-013703

(51) Int. Cl. G01P 15/08

(52) U.S. Cl. 73/504.12

(57) ABSTRACT

A piezoelectric vibration gyro element formed by etching from a quartz substrate of a Z-plate, includes: a base portion, a pair of vibration arms for detection extending from the base portion toward both sides thereof in the direction of Y-axis, a pair of coupling arms extending from the base portion toward both sides thereof in the direction of X-axis, pairs of vibration arms for driving extending from the end portions of the coupling arms toward both sides thereof in the direction of Y-axis, four beams extending from the base portion, and support portions connected to the ends of the beams, which are all arranged on an XY plane; wherein the beams are extending in the directions of about 30° or about 60° with the X-axis as a reference.

### BACKGROUND

1. Technical Field

The present invention relates to a piezoelectric vibration gyro element formed by etching, to a structure for supporting the piezoelectric vibration gyro element and to a gyro sensor.

2. Related Art

In recent years, there has been much used a gyro sensor incorporating a vibration gyro element in a container for correcting unintentional movement of the hands holding a camera device and for controlling the attitude of a mobile navigation system such as that used in a motor vehicle by using GPS satellite signals.

As the vibration gyro element, there has been known a so-called double T-shaped gyro element in which, for example, a drive vibration system of nearly a T-shape is coupled to a base portion to which a vibration detection system is coupled (see JP-A-2001-12955, FIG. 1). The double T-shaped gyro element adheres to and supports the base portion, and detects angular velocity. In order to improve the supporting strength of the vibration gyro element, however, there has been proposed a structure in which beams extend from the base portion, and both the base portion and end portions of the beams are supported (see JP-A-2001-12955, FIG. 4).

When the above vibration gyro element is to be formed by using quartz which is a piezoelectric material, it is a generally accepted practice to use a quartz substrate of a Z-plate and to conduct the etching by utilizing a photolithography technology. FIG. 10 is a plan view schematically illustrating a piezoelectric vibration gyro element integrally formed by etching the quartz.

In FIG. 10, a piezoelectric vibration gyro element 100 includes vibration detection arms 101a, 101b coupled to a base portion 110, coupling arms 103a, 103b coupled to the base portion 110, and vibration driving arms 104a, 104b, 105a and 105b extending from the end portions of the coupling arms 103a and 103b. Further, beside the vibration detection arms 101a and 101b are formed beams 111a, 111b, 112a and 112b extending from the base portion 110, with their ends connected to support portions 113 and 114.

In the above piezoelectric vibration gyro element 100, however, fin-like irregular portions 120 are formed at portions where sides of the quartz parallel to the X-axis and to the Y-axis intersect. The fin-like irregular portions 120 are formed due to the etching anisotropy stemming from a difference in the rate of etching varying according to angle with the directions of the axes of the crystalline structure of the quartz. The fin-like irregular portions 120 impart rigidity to the vibration detection arms 101a and 101b, and work to impair the vibration thereof.

To provide the piezoelectric vibration gyro element 100 in a small size, the base portion 110 is designed to be a relatively small size. Thus, the gap decreases, for example, between the vibration detection arm 101a and the beams 111a, 111b, and the fin-like irregular portions 120 formed from the sides of the beams 111a, 111b are overlapped on the fin-like irregular portions formed from the sides of the vibration detection arm 101a, increasing the rigidity of the vibration detection arm 101a and greatly impairing its vibration. Therefore, there arouses a problem in that the amplitude of vibration of the vibration detection arms 101a and 101b decreases, and the sensitivity for detecting the angular velocity decreases.

### SUMMARY

An advantage of an aspect of the present invention is that it provides a piezoelectric vibration gyro element which does not readily form fin-like irregular portions on the beams extending from the base portion, maintains sensitivity for detecting the angular velocity, and can be decreased in size, a structure for supporting the piezoelectric vibration gyro element and a gyro sensor.

In order to solve the above problems, the piezoelectric vibration gyro element of an aspect of the invention is formed by etching a quartz substrate of a Z-plate, comprising:

a base portion,

two vibration detection arms extending from the base portion toward the two directions in the Y-axis,

two coupling arms extending from the base portion toward the two directions in the X-axis,

two pairs of vibration driving arms, extending from the end portions of the coupling arm, toward the two directions in the Y-axis,

four beams extending from the base portion, and

support portions connected to the ends of the beams,

which are all arranged on the XY plane;

wherein the beams extend in directions about 30° or about 60° from the X-axis.

It has been known that formation of fin-like irregular portions is slight when the quartz substrate of the Z-plate is worked by etching to obtain members that extend in directions about 30° or about 60° from the X-axis. In this case, fin-like irregular portions are not readily formed on the beams, and the vibration of the vibration detection arms is not impaired.

Therefore, there can be provided a piezoelectric vibration gyro element maintaining sensitivity for detecting the angular velocity and which also can be decreased in size.

Further, the piezoelectric vibration gyro element of an aspect the invention has a feature in that the beams and the support portions are provided at rotationally symmetrical positions with respect to the center of gravity of the piezoelectric vibration gyro element.

According to this constitution, the piezoelectric vibration gyro element is balanced, and a stable attitude is maintained.

Further, the structure for supporting the piezoelectric vibration gyro element of the invention comprises the piezoelectric vibration gyro element, a support base on which the piezoelectric vibration gyro element is placed, and a fixing member for fixing the support portions of the piezoelectric vibration gyro element to the support base.

According to this constitution, the support portions are formed having increased areas. Therefore, even without supporting the base portion of the piezoelectric vibration gyro element, the support portions are reliably supported by the fixing member, maintaining sensitivity for detecting the angular velocity.

In the structure for supporting the piezoelectric vibration gyro element of the invention, further, the fixing member is a material having elasticity.

According to this constitution, the fixing member having elasticity relaxes the vibration or the shock from the outer side making it possible to stably maintain the driving vibration and the detection vibration of the piezoelectric vibration gyro element. The fixing member works as a buffer member for the slight vibration that does leak to the support portions, so that the driving vibration and the detection vibration are little affected.

Another aspect of the invention provides a gyro sensor of the invention comprising:

the piezoelectric vibration gyro element,

a support base on which the piezoelectric vibration gyro element is placed,

a fixing member for fixing the support portions of the piezoelectric vibration gyro element to the support base,

a driving circuit for driving and vibrating the piezoelectric vibration gyro element, and

a detecting circuit for detecting the detection vibration that occurs on the piezoelectric vibration gyro element when an angular velocity is exerted on the piezoelectric vibration gyro element.

According to this constitution, there is provided a small gyro sensor maintaining a sensitivity for detecting the angular velocity of a piezoelectric vibration gyro element, improving the support strength and mounting the piezoelectric vibration gyro element of a small size.

### BRIEF DESCRIPTION OF THE DRAWINGS

The invention will be described with reference to the accompanying drawings, wherein like numbers reference like elements.

FIG. 1 is a plan view schematically illustrating a piezoelectric vibration gyro element according to an embodiment.

FIG. 2 is a sectional view schematically illustrating a gyro sensor.

FIG. 3 is a plan view schematically illustrating the piezoelectric vibration gyro element in the state of driving vibration.

FIG. 4 is a plan view schematically illustrating the piezoelectric vibration gyro element in the state of detecting vibration.

FIG. 5 is a plan view schematically illustrating a modified piezoelectric vibration gyro element.

FIG. 6 is a plan view schematically illustrating a modified piezoelectric vibration gyro element.

FIG. 7 is a plan view schematically illustrating a modified piezoelectric vibration gyro element.

FIG. 8 is a plan view schematically illustrating a modified piezoelectric vibration gyro element.

FIG. 9 is a plan view schematically illustrating a modified piezoelectric vibration gyro element.

FIG. 10 is a plan view schematically illustrating a conventional piezoelectric vibration gyro element.

### DESCRIPTION OF THE EXEMPLARY EMBODIMENTS

Embodiments of the invention will now be described with reference to the drawings.

FIG. 1 is a plan view schematically illustrating a piezoelectric vibration gyro element according to an embodiment.

The piezoelectric vibration gyro element is formed by etching a Z-plate of quartz, utilizing a photolithography technology. The quartz has an X-axis called an electric axis, a Y-axis called a mechanical axis and a Z-axis called an optical axis. The Z-plate is a quartz substrate having a thickness in the direction of the Z-axis and having a flat surface on the XY plane.

The piezoelectric vibration gyro element 1 includes a pair of vibration detection arms 11a and 11b linearly extending from the base portion 10, one upward in the diagram and one downward, a pair of coupling arms 13a and 13b extending to the right and left from the base portion 10 at right angles with the vibration detection arms 11a and 11b, and right and left pairs of vibration driving arms 14a, 14b, 15a and 15b extending upward and downward from the end portions of the coupling arms 13a and 13b in parallel with the vibration detection arms 11a and 11b.

Further, detection electrodes (not shown) are formed on the surfaces of the vibration detection arms 11a and 11b, and driving electrodes (not shown) are formed on the surfaces of the vibration driving arms 14a, 14b, 15a and 15b. Thus, a detection vibration system for detecting the angular velocity is constituted by the vibration detection arms 11a, and 11b, and a driving vibration system for driving the piezoelectric vibration gyro element is constituted by the coupling arms 13a, 13b and by the vibration driving arms 14a, 14b, 15a and 15b.

Further, weighting portions 12a and 12b are formed at the ends of the vibration detection arms 11a and 11b, and weighting portions 16a, 16b, 17a and 17b are formed at the ends of the vibration driving arms 14a, 14b, 15a and 15b, in order to improve the sensitivity for detecting the angular velocity. Here, the vibration detection arms 11a and 11b include the weighting portions 12a and 12b, and the vibration driving arms 14a, 14b, 15a and 15b include the weighting portions 16a, 16b, 17a and 17b.

Further, four beams 20a, 20b, 21a and 21b are extending from the four corners of the base portion 10 in directions about 60° from the X-axis. The ends of the beams 20a, 20b, 21a and 21b are coupled to the support portions 22a, 22b, 23a and 23b, respectively. Here, the angle of about 60° of the beams 20a, 20b, 21a and 21b is allowed to be in a range of 60°±5°, taking the dispersion during production steps into consideration.

The beams 20a, 20b, 21a and 21b as well as the support portions 22a, 22b, 23a and 23b are provided at rotationally symmetrical positions with respect to the center of gravity G of the piezoelectric vibration gyro element 1.

Next, described below is the operation of the piezoelectric vibration gyro element 1.

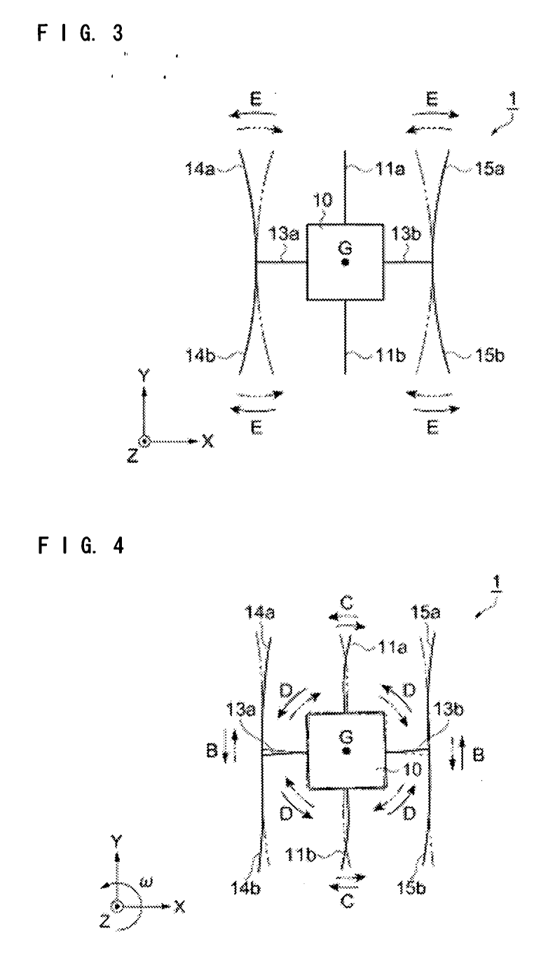

FIGS. 3 and 4 are plan views schematically illustrating the operation of the piezoelectric vibration gyro element. In FIGS. 3 and 4, the vibration arms are represented by lines to simply convey the state of vibration, while the above-mentioned beams 20a, 20b, 21a and 21b and the support portions 22a, 22b, 23a and 23b are omitted.

FIG. 3 illustrates a state of driving vibration of the piezoelectric vibration gyro element 1. In a state where no angular velocity is exerted on the piezoelectric vibration gyro element 1, the vibration driving arms 14a, 14b, 15a and 15b undergo the bending vibration in the directions indicated by arrows E. The bending vibration oscillates between the attitude of vibration indicated by solid lines and the attitude of vibration indicated by two-dot chain lines at a predetermined frequency. Here, the vibration driving arms 14a, 14b and the vibration driving arms 15a, 15b vibrate symmetrically with respect to the Y-axis passing through the center of gravity G and, hence, the base portion 10, coupling arms 13a, 13b and the vibration detection arms 11a, 11b hardly vibrate at all.

In this state of driving vibration, if an angular velocity ω about the Z-axis is exerted on the piezoelectric vibration gyro element 1, the vibration becomes as shown in FIG. 4. That is, the Coriolis force in the direction of arrows B acts on the vibration driving arms 14a, 14b, 15a, 15b and on the coupling arms 13a, 13b that constitute the driving vibration system, and a new vibration is excited. The vibration in the direction of arrows B is the vibration in the circumferential direction with respect to the center of gravity G. At the same time, further, the vibration detection arms 11a, 11b resonate with the vibration of arrows B, generating a detection vibration in the direction of arrows C. The distortion of the piezoelectric material generated by the vibration is detected by the detection electrodes formed on the vibration detection arms 11a and 11b, whereby the angular velocity can be determined.

At this time, further, the peripheral edges of the base portion 10 vibrate in the circumferential direction relative to the center of gravity G. This is because, not only are the symmetrical vibrations of the driving vibration system and the vibration detection arms 11a, 11b detection vibrations, but also the symmetrical vibration of the base portion 10 is detection vibration. The amplitude of vibration of the peripheral edges of the base portion 10 indicated by arrows D is much smaller than the amplitude of vibration of the driving vibration system indicated by arrows B or the amplitude of vibration of the vibration detection arms 11a, 11b indicated by arrows C. Here, if, for example, the base portion 10 is fixed by adhesion, the vibration of peripheral edges of the base portion 10 is suppressed by the fixing, and the detection vibration also is suppressed. Accordingly, the sensitivity for detecting the angular velocity decreases if the base portion 10 is supported.

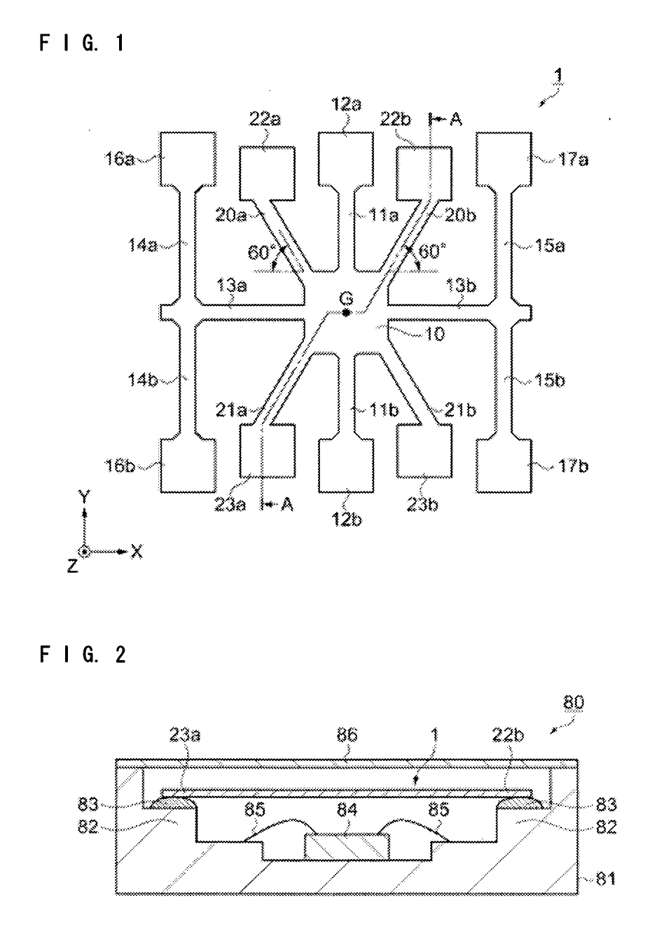

Next, the structure for supporting the piezoelectric vibration gyro element and the gyro sensor will be described with reference to FIG. 2 which is a sectional view schematically illustrating the gyro sensor, i.e., illustrating the piezoelectric vibration gyro element 1 along the line A-A in FIG. 1.

The gyro sensor 80 includes the piezoelectric vibration gyro element 1, an IC 84, a container 81 and a closure 86. The IC 84 is arranged on the bottom surface of the container 81 which is made of a ceramic material, and the IC 84 is electrically connected to a wiring (not shown) formed on the container 81 though wires 85 of Au or the like. The IC 84 includes a driving circuit for driving and vibrating the piezoelectric vibration gyro element 1, and a detection circuit for detecting the detection vibration produced in the piezoelectric vibration gyro element 1 when an angular velocity is exerted thereon. The piezoelectric vibration gyro element 1 is attached to and supported via fixing members 83 between the support base 82 formed in the container 81 and support portions 22a, 22b, 23a and 23b of piezoelectric vibration gyro element 1. Further, a wiring (not shown) is formed on the surface of the support base 82, and the electrodes of the piezoelectric vibration gyro element 1 are electrically conducted to the wiring through the fixing member 83. It is desired that the fixing member 83 is made of an elastic material. For the fixing member 83 having elasticity, there has been known an electrically conducting adhesive using silicone as a base material. The upper part of the interior of the container 81 is maintained as a vacuum which is sealed with the closure 86.

In the piezoelectric vibration gyro element 1 of this embodiment, the directions in which the beams 20a, 20b, 21a and 21b extend are set to be about 60° from the X-axis. It has been known that formation of fin-like irregular portions is slight when the quartz substrate of the Z-plate is worked by etching to obtain members that extend in directions about 30° or about 60° from the X-axis. In this case, formation of fin-like irregular portions is slight in the case where the beams 20a, 20b, 21a and 21b are coupled to the base portion 10, and the vibration of the vibration detection arms 11a and 11b is not impaired.

Therefore, there can be provided a piezoelectric vibration gyro element 1 maintaining the sensitivity for detecting the angular velocity, yet can be decreased in size.

Further, the beams 20a, 20b, 21a and 21b extending from the base portion 10 are formed by quartz and thus have elasticity, so that the vibration is not suppressed at the peripheral edges of the base portion 10 and the sensitivity for detecting the angular velocity does not decrease.

Further, the beams 20a, 20b, 21a and 21b as well as the support portions 22a, 22b, 23a and 23b are provided at rotationally symmetrical positions with respect to the center of gravity G of the piezoelectric vibration gyro element 1. Therefore, the piezoelectric vibration gyro element 1 maintains a balance and a stable attitude, and exhibits good characteristics.

In the structure for supporting the piezoelectric vibration gyro element 1 of this embodiment, further, there are formed support portions 22a, 22b, 23a and 23b for coupling the beams 20a, 20b, 21a and 21b extending from the base portion 10, making it possible for the support portions 22a, 22b, 23a 23b to have large areas, and to improve the strength for support.

In the structure for supporting the piezoelectric vibration gyro element 1, further, the fixing member 83 is made of a material having elasticity, and relaxes the vibration or the shock from the outer side making it possible to maintain stability in the driving vibration and in the detection vibration. The fixing member 83 works as a buffer member, and the driving vibration and the detection vibration are little affected by the small amount of vibration leaking onto the support portions 22a, 22b, 23a and 23b.

Further, the gyro sensor 80 mounting the piezoelectric vibration gyro element 1 supported by the above support structure can be reduced in size, and yet maintain high sensitivity for detecting the angular velocity.

Modified Piezoelectric Vibration Gyro Elements:

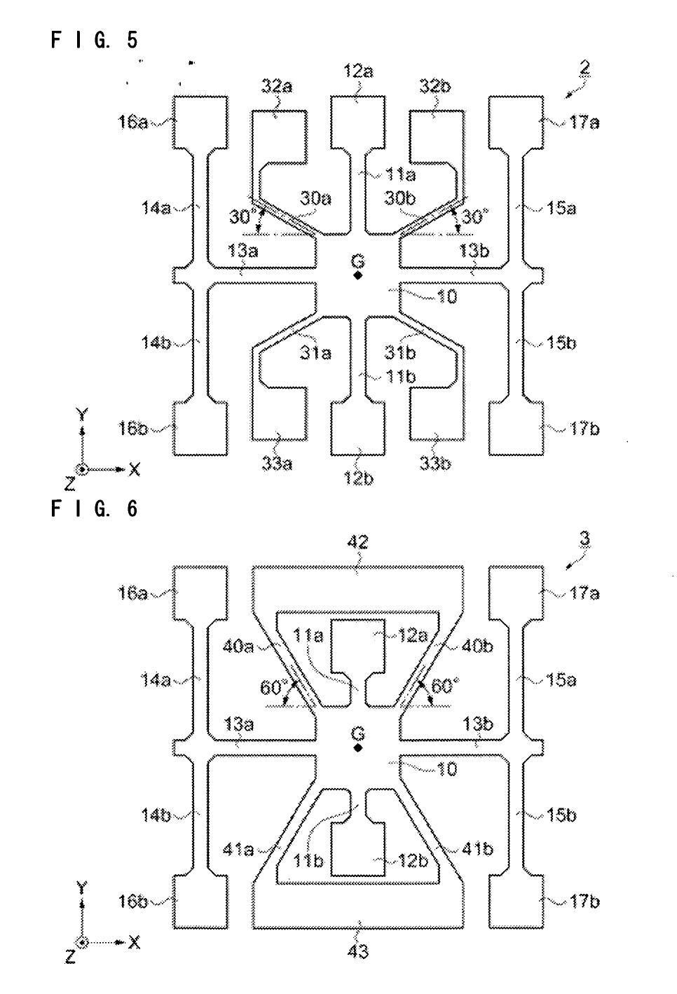

FIGS. 5 to 9 are plan views schematically illustrating modified piezoelectric vibration gyro elements. These modified examples have features in the shapes of the beams and the support portions shown in FIG. 1. Therefore, the same constituent portions as those of FIG. 1 are denoted by the same reference numerals but their description is not repeated.

In FIG. 5, a piezoelectric vibration gyro element 2 has four beams 30a, 30b, 31a and 31b extending from the four corners of the base portion 10 in directions about 30° from the X-axis. The ends of the beams 30a, 30b, 31a and 31b are coupled to the support portions 32a, 32b, 33a and 33b, respectively. Here, the angle of about 30° of the beams 30a, 30b, 31a and 31b is allowed to be in a range of 30°±5° taking dispersion during the production steps into consideration.

By using the same support structure as that of the above embodiment, the piezoelectric vibration gyro element 2 has its support portions 32a, 32b, 33a and 33b adhered to, and supported by, the support base by using a fixing member such as an electrically conducting adhesive.

In FIG. 6, a piezoelectric vibration gyro element 3 has four beams 40a, 40b, 41a and 41b extending from the four corners of the base portion 10 in directions about 60° from the X-axis. The ends of the beams 40a and 40b are both coupled to a support portion 42, and the ends of the beams 41a and 41b are coupled to a support portion 43. The vibration detection arms 11a and 11b are formed to be shorter than the vibration driving arms 14a, 14b, 15a and 15b, and the pair of support portions 42 and 43 are arranged beyond the vibration detection arms 11a and 11b in the directions in which the vibration detection arms 11a and 11b extend, and respectively between the vibration driving arms 14a and 15a, and 14b and 15b.

By using the same support structure as that of the above embodiment, the piezoelectric vibration gyro element 3 has its support portions 42 and 43 adhered to, and supported by, the support base by using a fixing member such as an electrically conducting adhesive.

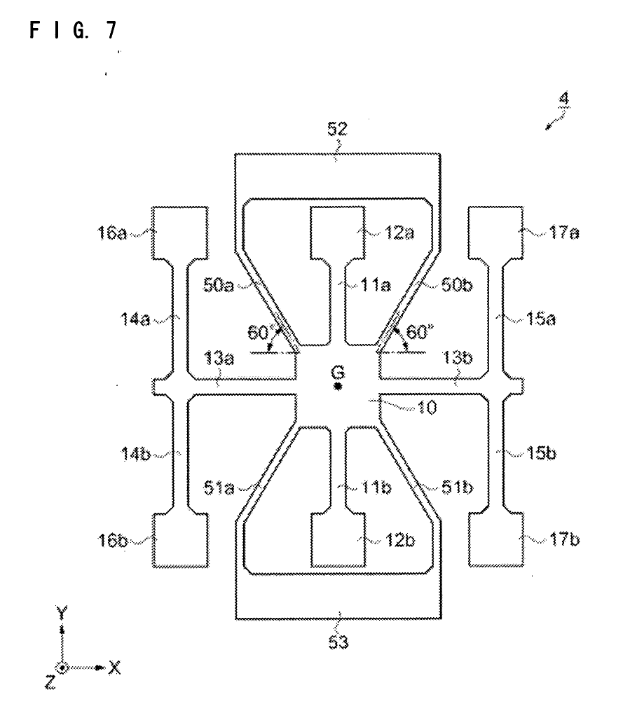

In FIG. 7, a piezoelectric vibration gyro element 4 has four beams 50a, 50b, 51a and 51b that are extending from the four corners of the base portion 10 in directions about 60° from the X-axis. The ends of the beams 50a and 50b are both coupled to a support portion 52, and the ends of the beams 51a and 51b are both coupled to a support portion 53. The pair of support portions 52 and 53 are arranged beyond the vibration detection arms 11a, 11b and also beyond the vibration driving arms 14a, 14b, 15a and 15b in the directions in which the vibration detection arms 11a and 11b are extending.

By using the same support structure as that of the above embodiment, the piezoelectric vibration gyro element 4 has its support portions 52 and 53 adhered to, and supported by, the support base by using a fixing member such as an electrically conducting adhesive.

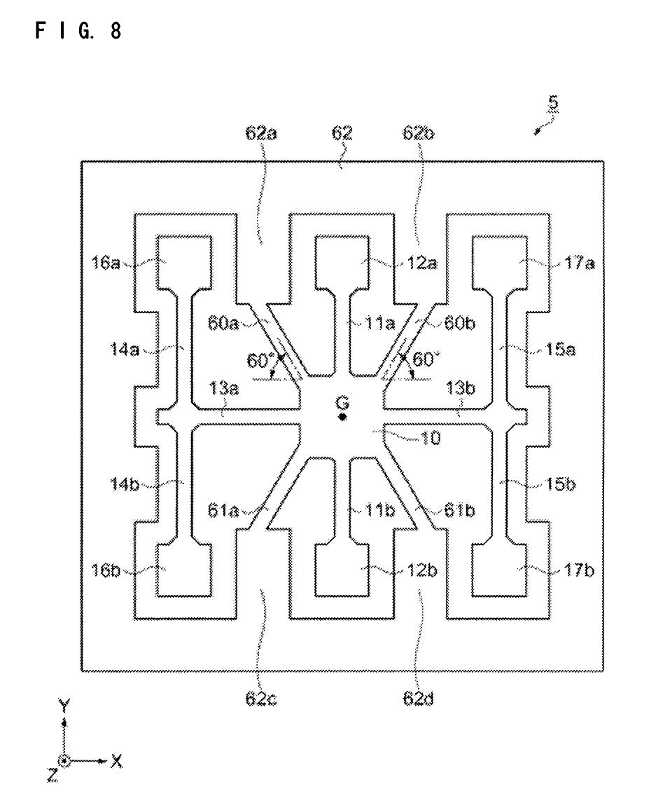

In FIG. 8, a piezoelectric vibration gyro element 5 has four beams 60a, 60b, 61a and 61b extending from the four corners of the base portion 10 in directions about 60° from the X-axis. Support portions 62a, 62b, 62c and 62d are connected to the beams 60a, 60b, 61a and 61b. The support portions 62a, 62b, 62c and 62d are further coupled to a frame portion 62 which is so formed as to surround the base portion 10, vibration detection arms 11a, 11b and vibration driving arms 14a, 14b, 15a and 15b.

By using the same support structure as that of the above embodiment, the piezoelectric vibration gyro element 5 has at least its support portions 62a, 62b, 62c, 62d or the frame portion 62 adhered to, and supported by, the support base by using a fixing member such as an electrically conducting adhesive.

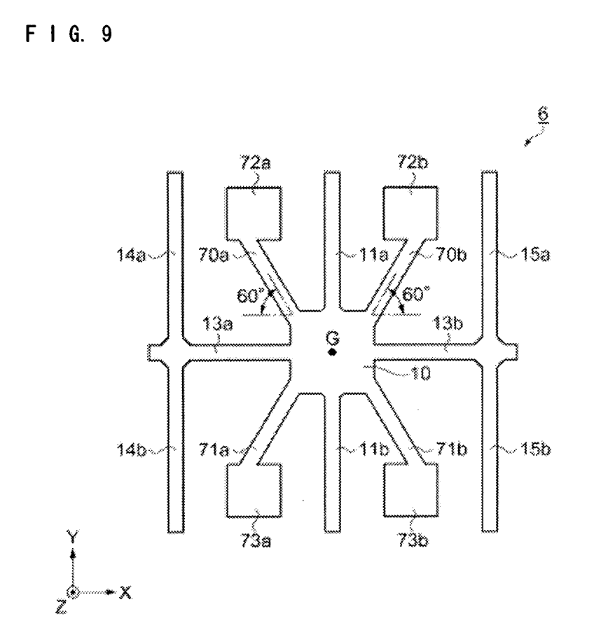

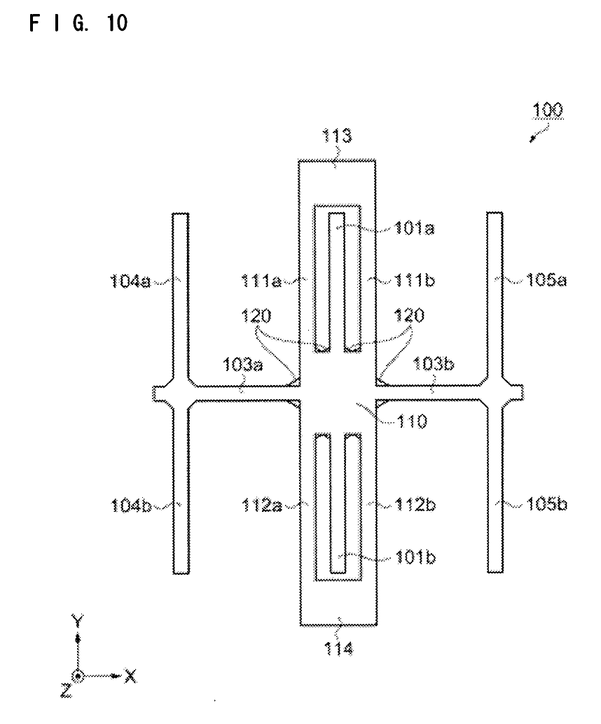

FIG. 9 illustrates a piezoelectric vibration gyro element in a state where the piezoelectric vibration gyro element 1 described with reference to FIG. 1 is provided with none of the weighting portions 16a, 16b, 17a or 17b.

The piezoelectric vibration gyro element 6 has four beams 70a, 70b, 71a and 71b that are extending from the four corners of the base portion 10 in directions about 60° from the X-axis. Support portions 72a, 72b, 73a and 73b are connected to the ends of the beams 70a, 70b, 71a and 71b.

By using the same support structure as that of the above embodiment, the piezoelectric vibration gyro element 6 has its support portions 72a, 72b, 73a and 73b adhered to, and supported by, the support base by using a fixing member such as an electrically conducting adhesive.

In the above piezoelectric vibration gyro elements 2, 3, 4, 5 and 6, the beams and the support portions are provided at rotationally symmetrical positions with respect to the centers of gravity G of the piezoelectric vibration gyro elements 2, 3, 4, 5 and 6.

As described above, formation of fin-like irregular portions is slight where the beams are coupled to the base portion 10 of the piezoelectric vibration gyro element in the case where the beams are worked by etching to extend from the base portion 10 in directions about, 30° or about 60° from the X-axis, and the vibration of the vibration detection arms 11a and 11b is not impaired.

The above modified piezoelectric vibration gyro elements, too, exhibit the effects same as those of the embodiment described above.

The entire disclosure of Japanese Patent Application No. 2005-013703, filed Jan. 21, 2005 is expressly incorporated by reference herein.

What is claimed is:

1. A piezoelectric vibration gyro element formed by etching from a quartz substrate of a Z-plate, comprising:
a base portion,
a pair of vibration detection arms extending from the base portion toward the two directions in the Y-axis,
a pair of coupling arms extending from the base portion toward the two directions in the X-axis,
pairs of vibration driving arms extending from the end portions of the coupling arms toward the two directions in the Y-axis,
four beams extending from the base portion, and
support portions connected to the ends of the beams,
which are all arranged on the XY plane;
wherein the beams extend in directions about 30° or about 60° from the X-axis.

2. A piezoelectric vibration gyro element according to claim 1, wherein the beams and the support portions are provided at rotationally symmetrical positions with respect to the center of gravity of the piezoelectric vibration gyro element.

3. A structure for supporting a piezoelectric vibration gyro element, comprising:
the piezoelectric vibration gyro element of claim 1,
a support base on which the piezoelectric vibration gyro element is placed, and
a fixing member for fixing the support portions of the piezoelectric vibration gyro element to the support base.

4. A structure for supporting a piezoelectric vibration gyro element according to claim 3, wherein the fixing member is a material having elasticity.

5. A gyro sensor comprising:
a piezoelectric vibration gyro element of claim 1,
a support base on which the piezoelectric vibration gyro element is placed,
a fixing member for fixing the support portions of the piezoelectric vibration gyro element to the support base,
a driving circuit for driving and vibrating the piezoelectric vibration gyro element, and
a detecting circuit for detecting the detection vibration that occurs on the piezoelectric vibration gyro element when an angular velocity is given to the piezoelectric vibration gyro element.

6. A piezoelectric vibration gyro element according to claim 2, wherein the beams and the support portions are provided at rotationally symmetrical positions with respect to the center of gravity of the piezoelectric vibration gyro element.

7. A gyro sensor comprising:
a piezoelectric vibration gyro element of claim 2,
a support base on which the piezoelectric vibration gyro element is placed,
a fixing member for fixing the support portions of the piezoelectric vibration gyro element to the support base,
a driving circuit for driving and vibrating the piezoelectric vibration gyro element, and
a detecting circuit for detecting the detection vibration that occurs on the piezoelectric vibration gyro element when an angular velocity is given to the piezoelectric vibration gyro element.
